(19) United States
(12) Patent Application Publication
(10) Pub. No.: US 2004/0199769 A1
(43) Pub. Date: Oct. 7, 2004

(54) Provision of commands to computing apparatus

(76) Inventor: Graeme John Proudler, Bristol (GB)

Correspondence Address: HEWLETT-PACKARD COMPANY, Intellectual Property Administration, P.O. Box 272400, Fort Collins, CO, 80527-2400, US

(21) Appl. No.: 10/819,465

(22) Filed: Apr. 6, 2004

(30) Foreign Application Priority Data
Apr. 7, 2003 (GB) 0307986.0

(51) Int. Cl. G06F 11/30

(52) U.S. Cl. 713/169

(57) ABSTRACT

A computer system comprises a processor that is arranged to alter at least one aspect of operation only if a command to alter that at least one aspect is provided by a valid user. For this aspect of operation, a valid user may be a user authenticated by the processor by establishing that the user possesses a secret, or may be a user who satisfies a condition for physical presence at the computer system. However, for a predetermined time after authentication by establishment of possession of the secret has taken place, the processor will not be responsive to the or each such command when issued by a user who is not authenticated by the processor but who satisfies a condition for physical presence at the computer system. This approach is of particular value in the provision of commands to a trusted component of trusted computing apparatus.

### FIELD OF THE INVENTION

The present invention relates to provision of commands to computing apparatus, in particular for computing apparatus that requires conditions to be met of the issuer of commands to the computing apparatus before those commands will be carried out.

### DISCUSSION OF PRIOR ART

While some computing apparatus is not secure and can be freely used by any user, it is frequently not desirable for this to be the case. Frequently, use of computing apparatus will be restricted to particular users who will not be allowed to advance the machine to a useful state without some kind of authentication exchange (such as the provision of a user name and a password).

A recent development is the provision of computing apparatus that is “trusted”—that is, it can be relied on by the user to behave in a predictable manner and that subversion by another will at the least be apparent. In the Trusted Computing Platform Alliance specification (found at www.trustedcomputing.org) and in the associated book “Trusted Computing Platforms: TCPA Technology in Context”, edited by Siani Pearson and published July 2002 by Prentice Hall PTR (the contents of which are incorporated by reference herein to the extent permissible by law), there is described an approach to trusted computing which employs a trusted coprocessor (both physically and logically protected from subversion) to assure a user of computing apparatus including or associated with the trusted coprocessor that it is performing in a predictable and unsubverted manner. A particularly useful arrangement, particularly where it is desirable to provide information and services for other computers, is to use both a compartmentalised operating system (typically by operating in a compartmentalised manner such that processes run in separated computing environments that have strictly controlled interaction with other computing environments) and trusted computing hardware using a trusted component (such an arrangement is discussed in, for example, the applicants' patent application published as EP1182557).

In a number of situations, the user will have no need to control the trusted element associated with computing apparatus, but as can readily be imagined, there are a number of circumstances in which some elements of control should, or even must, be provided—to allow new users to interact with the trusted element, to allow the trusted element to carry out new functions or to participate in new applications, and so on. Clearly if commands are to be provided to the trusted element, it is necessary to be confident that these are not provided by some third party trying to subvert the system. Two mechanisms are provided for this. The most attractive mechanism for general use is cryptographic authentication of a user to the trusted element—if this succeeds, then an associated command will be accepted. A second mechanism is generally provided because this first mechanism will not always be appropriate—there may, for example, be no authenticatable user (if the user has lost their authentication, or if the user's cryptographic identity has lapsed without a new one being made known to the trusted element)—potentially rendering the computing apparatus completely unusable (at the least, unusable in a trusted manner). There are several reasons why such a mechanism may be needed—another is that there may be insufficient computing resources available at any given time to carry out the necessary cryptographic processing.

This second mechanism is typically the physical presence of a user—typically achieved by physical intervention while the computing apparatus is booted. While this process is generally effective to address the subversion most generally feared (automatic remote subversion), physical presence can only be made completely secure by dedicated mechanisms such as discrete switches connected only to the trusted coprocessor. These solutions are too expensive for practical use in general purpose computing apparatus, leaving available for practical use physical presence mechanisms such as making requested keystrokes during the boot process—even if there are not currently ways to subvert mechanisms such as this, there does nonetheless appear to be potential for automatic remote subversion. More significantly, however, physical presence merely proves the presence of a person, not the presence of the actual owner. If physical presence commands affect the security of a trusted platform, instead of just the availability of security mechanisms, there is therefore some risk that the security of the platform may be compromised by physical presence commands activated by the user instead of the genuine owner.

Current systems thus strike an undesirable compromise between security and cost in providing physical presence mechanisms for providing commands to the trusted element of trusted computing apparatus. This undesirable compromise is clearly present in current trusted computing apparatus, but applies more generally to provision of commands to computing apparatus where some conditions should be met by the issuer of commands before their commands are carried out.

### SUMMARY OF THE INVENTION

Accordingly, in a first aspect, the invention provides a computer system comprising a processor arranged to alter at least one aspect of operation only if a command to alter that at least one aspect is provided by a valid user, whereby for the at least one aspect of operation, a valid user may be a user authenticated by the processor by establishing that the user possesses a secret or a user who satisfies a condition for physical presence at the computer system; and whereby for a predetermined time after authentication by establishment of possession of the secret has taken place, the processor is adapted not to be responsive to the command to alter that at least one aspect when issued by a user who is not authenticated by the processor but who satisfies a condition for physical presence at the computer system.

This approach has the advantage of suppressing use of physical presence to provide the relevant command to the computer system. By appropriate choice of the predetermined time, it can be made the case that this mechanism will be suppressed during “normal” use of the platform, but will be available after a reasonable period if user authentication becomes impossible (and will be available directly if there is as yet no authenticable user).

In cases of particular interest, a computing platform comprises a main processor and a computer system as indicated above as a coprocessor. The computer system indicated above may therefore be, for example, the trusted device of a trusted computing platform.

In a further aspect, the invention provides a method of control of a processor responsive to a command or commands to alter at least one aspect of operation only if provided under specified conditions, comprising the steps of:

the processor authenticating the user by establishing that they possess a secret and starting a timer;

if a predetermined period has not elapsed on the timer, the processor refusing to respond to the at least one command issued by a user who demonstrates physical presence at a computer system comprising the processor but does not provide authentication by possession of the secret; and

if the predetermined period has elapsed on the timer, the processor responding to the at least one command issued by a user who demonstrates physical presence at the computer system comprising the processor.

In a still further aspect, the invention provides a trusted computing platform containing a main processor and a trusted component, the trusted component being physically and logically resistant to subversion and containing a trusted component processor, wherein the trusted component processor is adapted to report on the integrity of at least some operations carried out on the main processor and has at least one command to which it is responsive only if it is provided by a valid user of the trusted computing platform; whereby for the at least one command, a valid user may be a user authenticated by the trusted component processor by establishing that the user possesses a secret or a user who satisfies a condition for physical presence at the trusted computing platform; and whereby for a predetermined time after authentication by establishment of possession of the secret has taken place, the trusted component processor is adapted not to be responsive to the at least one command when issued by a user who is not authenticated by the processor but who satisfies a condition for physical presence at the computer system.

In a yet further aspect, the invention provides a data carrier having stored thereon executable code whereby a processor programmed by the executable code:

recognises a command or commands to alter at least one aspect of operation which can be made to the processor as being executable only if provided by a valid user;

identifies a valid user for the at least one command as being a user authenticated by the processor as the possessor of a secret;

on determination that a user has been authenticated by the processor as the possessor of a secret, starts timing for a predetermined period;

if the predetermined period has not elapsed, refuses to respond to the at least one command issued by a user who is not authenticated as possessor of a secret but who is recognised by the processor as demonstrating physical presence at a computer system of which the processor is a part; and

if the predetermined period has elapsed, responding to the at least one command issued by a user who is recognised by the processor as demonstrating physical presence at the computer system of which the processor is a part.

In a yet further aspect, the invention provides a method of control of a processor responsive to a command or commands to alter at least one aspect of operation only if said command or commands is or are provided by a valid user, comprising the steps of:

determining a first method for the processor to identify a valid user having a higher level of assurance, and a second method for the processor to identify a valid user having a lower level of assurance;

the processor identifying the user with the first method and starting a timer;

if a predetermined period has not elapsed on the timer, the processor refusing to respond to the command or commands issued by a user identified by the second method but not by the first method; and

if the predetermined period has elapsed on the timer, the processor responding to the command or commands issued by a user identified by the second method.

In a yet further aspect, the invention provides a computer system comprising a processor arranged to alter at least one aspect of operation only if a command to alter that at least one aspect is provided by a valid user,

whereby for the at least one aspect of operation, a valid user may be a user identified by the processor by a method that provides a higher degree of assurance that the user is a valid user or by a method that provides a lower degree of assurance that the user is a valid user; and

whereby for a predetermined time after identification by the method that provides a higher degree of assurance, the processor is adapted not to alter the at least one aspect of operation by a user identified by the method that provides a lower degree of assurance.

### BRIEF DESCRIPTION OF DRAWINGS

For a better understanding of the invention and to show how the same may be carried into effect, there will now be described by way of example only, specific embodiments, methods and processes according to the present invention with reference to the accompanying drawings in which:

FIG. 1 is a diagram that illustrates schematically a system capable of implementing embodiments of the present invention;

FIG. 2 is a diagram which illustrates a motherboard including a trusted device arranged to communicate with a smart card via a smart card reader and with a group of modules;

FIG. 3 is a diagram that illustrates the trusted device of FIG. 2 in more detail;

FIG. 4 illustrates the elements of a computer system suitable for carrying out embodiments of the invention;

FIG. 5 illustrates schematically a first embodiment of the invention;

FIG. 6 is a diagram that illustrates the operational parts of a user smart card for use in accordance with embodiments of the present invention;

FIG. 7 is a flow diagram which illustrates the process of mutually authenticating a smart card and a host platform;

FIG. 8 illustrates schematically a mode of operation of the host platform and smart card in which an application running on the host platform requests authorization from the smart card;

FIG. 9 illustrates the steps followed by a computer system in implementing embodiments of a method according to the invention;

FIG. 10 illustrates modifications to the process illustrated in FIG. 7 in accordance with a second embodiment of the invention; and

FIG. 11 illustrates a trusted platform boot process in accordance with a second embodiment of the invention.

### DETAILED DESCRIPTION OF SPECIFIC EMBODIMENTS

We shall first describe a general example of a computing system in which authorisation is required to give certain commands, and application of a first embodiment of the invention to this system. We shall then describe trusted computing apparatus of the general type described in “Trusted Computing Platforms: TCPA Technology in Context”, and discuss application of a second embodiment of the invention in the context of this system.

Basic elements of a computer system to which either the first or second embodiments may apply is shown in FIG. 4. A computer system 40—in this case a personal computer—has a user interface provided by a keyboard 45 and a monitor 44. A dedicated switch 46 is used to provide a direct physical input to the processor of the computer system—generally, as will be described further below, such a dedicated switch is not provided but its function is provided by keyboard commands provided during the boot process of the computer system. To illustrate the range of user identification routes available, the computer system shown has two interfaces with other devices—a smart card reader interface to smart card reader 42 used for reading a user smart card 41, and a network interface to network 43. A user identity can be provided through the keyboard user interface, through the smart card reader 42 from user smart card 41, or over network 43 (in practice, one, two or all of these routes may be present, and the skilled person will appreciate that further alternatives may be possible).

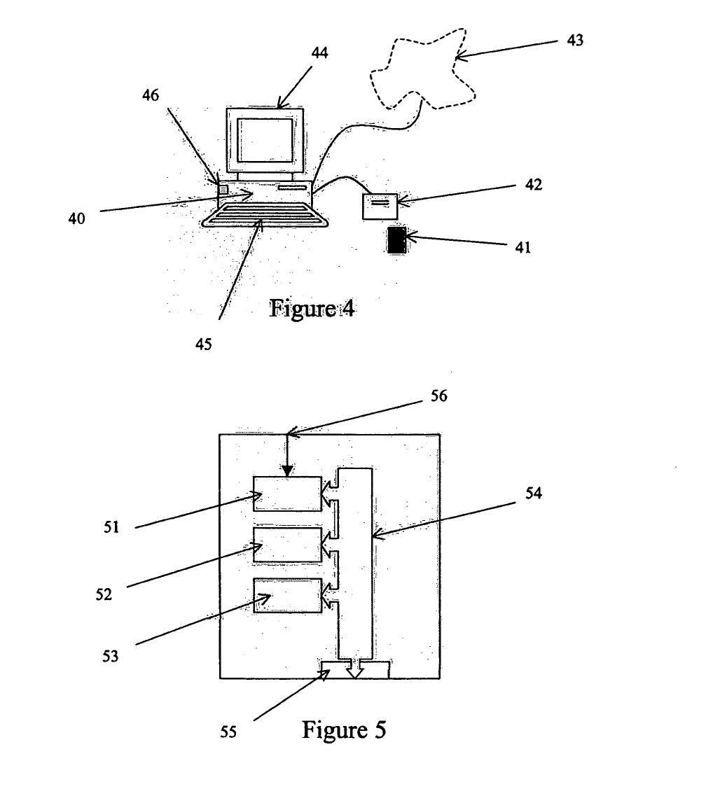

Schematically, the elements of system sufficient to carry out embodiments of the invention are shown in FIG. 5. Processor 51 communicates with memory 52 and clock 53 by means of a bus 54—the bus is also in contact with input/output interface 55 (which could here describe the keyboard interface, a network interface, a smart card reader interface, or an interface to another input/output device). In addition, there is a dedicated input 56 to the processor from physical presence mechanism 56—in the FIG. 4 case, this is switch 46.

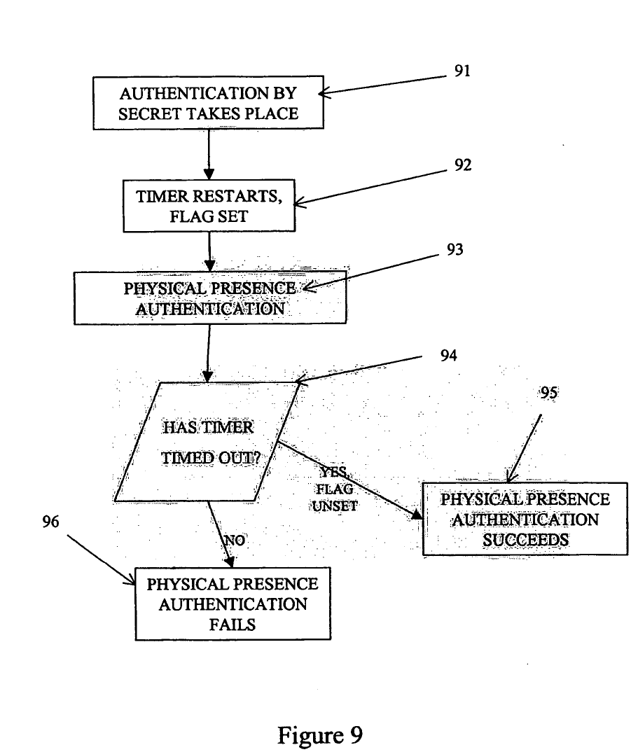

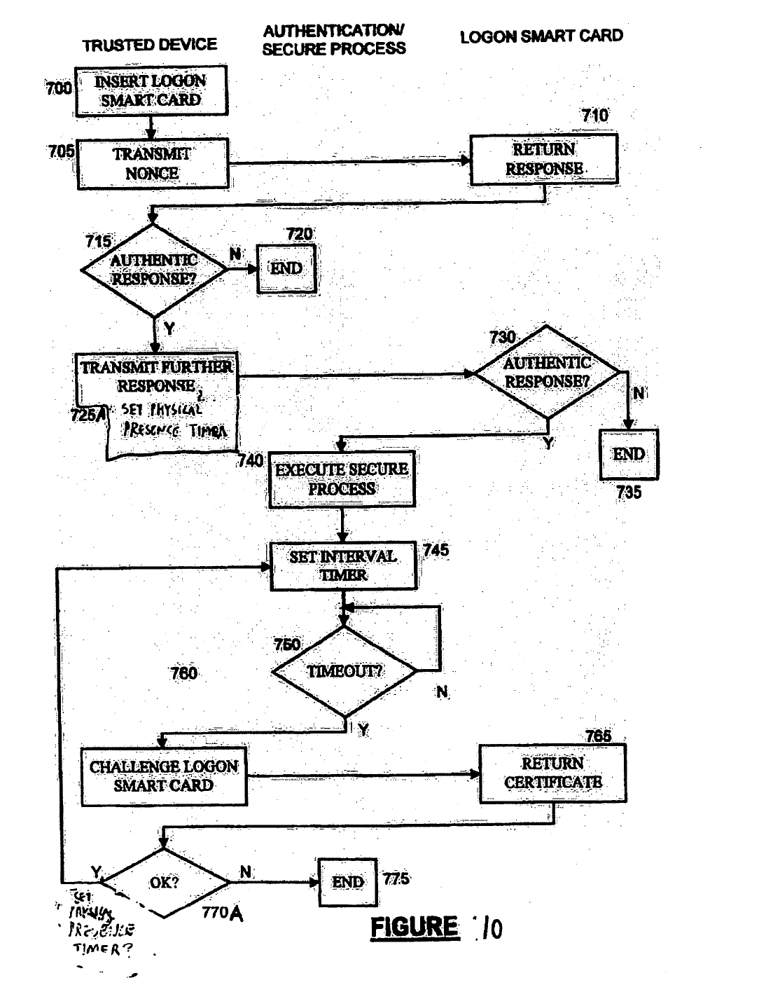

The functional steps carried out in the computer system in one embodiment of the invention are illustrated schematically in FIG. 9. At some point, identification by means of a secret takes place (step 91) through input/output interface 55. At its simplest, this could be the user typing a password on the keyboard on prompting by an appropriate application, the application recognising the password as being the secret associated with a valid user of the computer system. In a more secure system, the secret could be an identity held on the smart card 41, or on another machine in network 43, and the processor 51 could be adapted for cryptographic communication with the smart card 41 or with the entity elsewhere on the network 43 (appropriate approaches to such cryptographic communication are described further below with reference to the second embodiment of the invention). Clearly, the authenticated user can be remote from the computer system, and can even be a process, rather than a person.

Once authentication with the secret has taken place, a timer is started or, if it is already running, restarted (step 92). For this purpose the processor 51 can employ the clock 53 to run a subroutine to increment a counter in straightforward fashion (though it should be noted that it may be necessary to continue running the timer while the computer system is powered off—this may require obtaining clock information from a (reliable) external rather than an internal source). A flag in memory 52 is set to indicate that physical presence is disabled until the timer times out. On a subsequent attempt to command the processor with the physical presence mechanism (step 93), the processor 51 checks to see whether the timer has timed out. If no, the physical presence mechanism fails (step 96). If, however, the timer has timed out, the flag is reset, and the physical presence mechanism succeeds (step 95).

This physical presence timer may be termed a “watchdog timer”—it guards against a particular event or condition that is not allowed to take place during a particular timing interval.

It should be noted that user secrets may be used for several purposes, including authorisation to use keys inside the computer system. There may not be a single secret to which the timer is linked—for example, the timer may be restarted upon proof to the computer system of possession by an external entity of more than one secret used for authentication or for authorisation for actions. One useful option is for the timer to be set by a command that proves owner privilege without using physical presence and whose sole purpose is to set the timer.

The physical presence mechanism is used to issue commands relating to altering aspects of operation of the computer system. There may be a number of such commands (or such aspects). It is possible for there to be separate timers for different commands (or for different aspects of operation of the trusted device), but it may be more convenient to have one single timer in operation. Indeed, there is no reason why the command set for provision by an authenticated user should directly match the command set for provision by a physically present user.

The advantage of this approach is that physical presence authentication is not secure against a physically present unauthorised user (to obtain confidence that such a user will not be present, it will be necessary to prevent such users from physical access to the computer system), whereas authentication by a secret requires only that the user secures the secret, or the device on which the secret is held. In this approach, it will thus in most circumstances be easier to ensure that it is the owner of the trusted platform (that is, the person or other entity genuinely entitled to control the trusted device and hence the trusted platform) or other suitably authorised person who makes such commands, rather than any other person.

Once it is established that the user is in control of the secret (so there can be some confidence that the user is the owner of the computer system or someone with equivalent privileges), suppression of the physical presence mechanism improves the security of the computer system without disadvantage to the user (as the user has ready access to the secret). However, if the secret is lost or corrupted, the computer system will not become unusable (or not usable to its full capacity) for all time, because after an appropriate period of time the timer will time out and the physical presence mechanism will be operable to provide commands to the processor.

There may in this arrangement be multiple users with owner privileges—preferably, each of these could be able to set the timer to disable physical presence. As indicated above, there could be separate timers for different aspects of operation, or different physical presence commands. Moreover, different users may have permission to set different ones of these timers.

The appropriate period to choose for time out may vary depending on the context in which the computer system is used—preferably, the timeout period can be set by the owner of the computer system, again preferably by providing appropriate authentication to the computer system. A short timeout requires the owner to frequently set the watchdog, but enables rapid recovery of a TPM if the owner forgets his shared secret. A long timeout reduces the demands on the owner but means that recovery time is longer if the owner forgets his shared secret. For a computer system that is typically used every day, 48 hours may be an appropriate timeout period—the physical presence mechanism will then be disabled for the whole time that the system is in normal use (this may be desirable for many systems). For a computer system typically used every work day (but not every day), 72 hours or a week may be a more appropriate timeout period. An owner may typically choose to set the timeout to a day or a few days. The choice of timeout period clearly may be adjusted to provide the best balance between security and convenience should use of the secret be lost. The timeout period could also be used to activate other mechanisms to safeguard the content of memory 52 (or other aspects of the computer system) so these come into operation before the physical presence mechanism becomes enabled, so that such content is protected against use of the physical presence mechanism by an unauthorised user.

Having discussed a first, general, embodiment of the invention, the application of the invention to a trusted platform of the type discussed in the Trusted Computing Platform Alliance specification will now be described. Such platforms are described in earlier applications by the present applicants, in particular, International Patent Application Publication Nos. WO00/48063 and WO00/54126 which are incorporated by reference herein to the greatest extent possible under applicable law. The elements of an exemplary trusted platform and its operation will first be described—the elements and operation of a second embodiment of the invention will then be described with reference to the preceding general discussion of trusted platforms.

In this specification, the term “trusted” when used in relation to a physical or logical component, is used to mean that the physical or logical component always behaves in an expected manner. The behavior of that component is predictable and known. Trusted components have a high degree of resistance to unauthorized modification.

In this specification, the term “computer platform” is used to refer to a computer system comprising at least one data processor and at least one data storage means, usually but not essentially with associated communications facilities e.g. a plurality of drivers, associated applications and data files, and which may be capable of interacting with external entities e.g. a user or another computer platform, for example by means of connection to the internet, connection to an external network, or by having an input port capable of receiving data stored on a data storage medium, e.g. a CD ROM, floppy disk, ribbon tape or the like. The term “computer platform” encompasses the main data processing and storage facility of a computer entity.

By use of a trusted component in each computer entity, there is enabled a level of trust between different computing platforms. It is possible to query such a platform about its state, and to compare it to a trusted state, either remotely, or through a monitor on the computer entity. The information gathered by such a query is provided by the computing entity's trusted component which monitors the various parameters of the platform. Information provided by the trusted component can be authenticated by cryptographic authentication, and can be trusted. A “trusted platform” can thus be achieved by the incorporation into a computing platform of a physical trusted device whose function is to bind the identity of the platform to reliably measured data that provides an integrity metric of the platform. The identity and the integrity metric are compared with expected values provided by a trusted party (TP) that is prepared to vouch for the trustworthiness of the platform. If there is a match, the implication is that at least part of the platform is operating correctly, depending on the scope of the integrity metric.

The presence of the trusted component makes it possible for a piece of third party software, either remote or local to the computing entity to communicate with the computing entity in order to obtain proof of its authenticity and identity and to retrieve measured integrity metrics of that computing entity. For a human user to gain a level of trustworthy interaction with his or her computing entity, or any other computing entity which that person may interact with by means of a user interface, a trusted token device is used by a user to interrogate a computing entity's trusted component and to report to the user on the state of the computing entity, as verified by the trusted component. Authentication between the trusted component and the trusted token device is, in practical situations of interest, mutual—the user is authenticated by the trusted component, and (if the user has appropriate privileges) may be allowed to control it, and the trusted component is authenticated by the user (and recognised as a trusted component, and in appropriate circumstances a trusted component owned or controllable by the user).

The advantages and use in applications of a trusted platform of this type are discussed in some detail in International Patent Application Publication Nos. WO00/48063 and WO00/54126 and in considerable detail in “Trusted Computing Platforms: TCPA Technology in Context”, and will not be described further here.

The trusted component in such an arrangement uses cryptographic processes. A most desirable implementation would be to make the trusted component tamper-proof, to protect secrets by making them inaccessible to other platform functions and provide an environment that is substantially immune to unauthorised modification. Since complete tamper-proofing is impossible, the best approximation is a trusted device that is tamper-resistant, or tamper-detecting. The trusted device, therefore, preferably consists of one physical component that is tamper-resistant. Techniques of tamper-resistance are well known to the skilled person, and are discussed further in International Patent Application Publication Nos. WO00/48063 and WO00/54126.

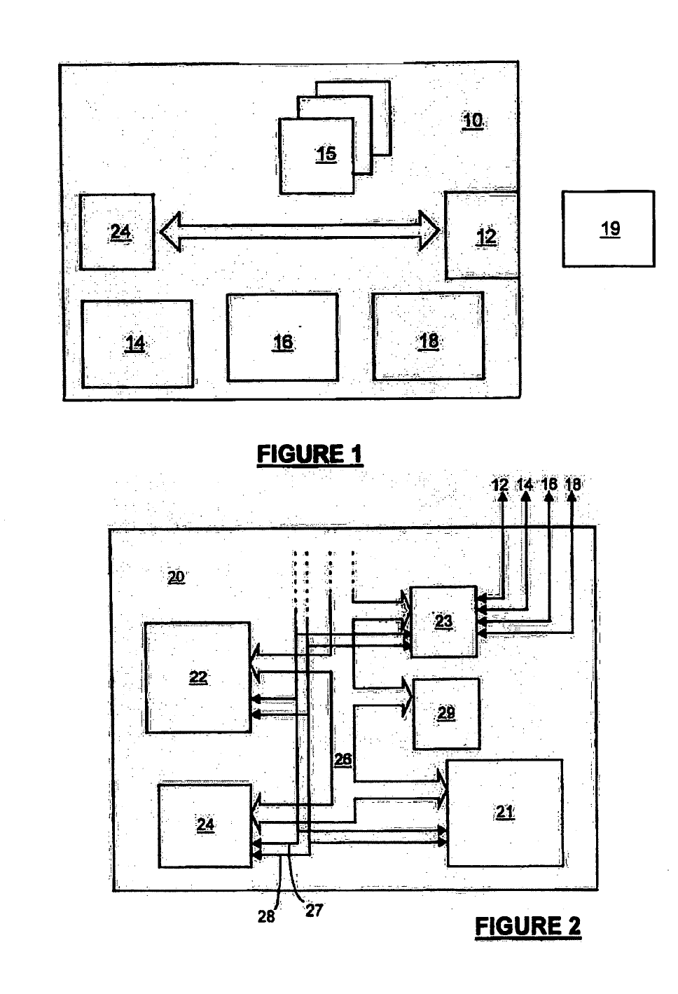

A trusted platform 10 is illustrated in the diagram in FIG. 1. The platform 10 includes the standard features of a keyboard 14 (which as will be described below is used to indicate the user's physical presence at the trusted platform), mouse 16 and monitor 18, which provide the physical ‘user interface’ of the platform. This embodiment of a trusted platform also contains a smart card reader 12. Alongside the smart card reader 12, there is illustrated a smart card 19 to allow trusted user interaction with the trusted platform as shall be described further below. In the platform 10, there are a plurality of modules 15: these are other functional elements of the trusted platform of essentially any kind appropriate to that platform. The functional significance of such elements is not relevant to the present invention and will not be discussed further herein. Additional components of the trusted computer entity will typically include one or more local area network (LAN) ports, one or more modem ports, and one or more power supplies, cooling fans and the like.

As illustrated in FIG. 2, the motherboard 20 of the trusted computing platform 10 includes (among other standard components) a main processor 21, main memory 22, a trusted device 24 (the physical form of the trusted component described above), a data bus 26 and respective control lines 27 and lines 28, BIOS memory 29 containing the BIOS program for the platform 10 and an Input/Output (IO) device 23, which controls interaction between the components of the motherboard and the smart card reader 12, the keyboard 14, the mouse 16 and the monitor 18 (and any additional peripheral devices such as a modem, printer, scanner or the like). The main memory 22 is typically random access memory (RAM). In operation, the platform 10 loads the operating system (and the processes or applications that may be executed by the platform), for example Windows XP™, into RAM from hard disk (not shown).

The computer entity can be considered to have a logical, as well as a physical, architecture. The logical architecture has a same basic division between the computer platform, and the trusted component, as is present with the physical architecture described in FIGS. 1 to 3 herein. That is to say, the trusted component is logically distinct from the computer platform to which it is physically related. The computer entity comprises a user space being a logical space which is physically resident on the computer platform (the first processor and first data storage means) and a trusted component space being a logical space which is physically resident on the trusted component. In the user space are one or a plurality of drivers, one or a plurality of applications programs, a file storage area; smart card reader; smart card interface; and a software agent which can perform operations in the user space and report back to trusted component. The trusted component space is a logical area based upon and physically resident in the trusted component, supported by the second data processor and second memory area of the trusted component. Monitor 18 receives images directly from the trusted component space. External to the computer entity are external communications networks e.g. the Internet, and various local area networks, wide area networks which are connected to the user space via the drivers (which may include one or more modem ports). An external user smart card inputs into smart card reader in the user space.

Typically, in a personal computer the BIOS program is located in a special reserved memory area, the upper 64K of the first megabyte of the system memory (addresses FØØØh to FFFFh), and the main processor is arranged to look at this memory location first, in accordance with an industry wide standard.

The significant difference between the platform and a conventional platform is that, after reset, the main processor is initially controlled by the trusted device, which then hands control over to the platform-specific BIOS program, which in turn initialises all input/output devices as normal. After the BIOS program has executed, control is handed over as normal by the BIOS program to an operating system program, such as Windows XP™, which is typically loaded into main memory 22 from a hard disk drive (not shown).

Clearly, this change from the normal procedure requires a modification to the implementation of the industry standard, whereby the main processor 21 is directed to address the trusted device 24 to receive its first instructions. This change may be made simply by hard-coding a different address into the main processor 21. Alternatively, the trusted device 24 may be assigned the standard BIOS program address, in which case there is no need to modify the main processor configuration.

A relatively secure platform can however be achieved without such a fundamental change. In such implementations, the platform is still controlled by the BIOS at switch-on, so the BIOS (or at least the BIOS boot block) must also be trusted. This means that there will not be a single root-of-trust (as in the preferred trusted platform embodiment described) but two—the BIOS boot block will also be a root of trust.

It is highly desirable for the BIOS boot block to be contained within the trusted device 24. This prevents subversion of the obtaining of the integrity metric (which could otherwise occur if rogue software processes are present) and prevents rogue software processes creating a situation in which the BIOS (even if correct) fails to build the proper environment for the operating system.

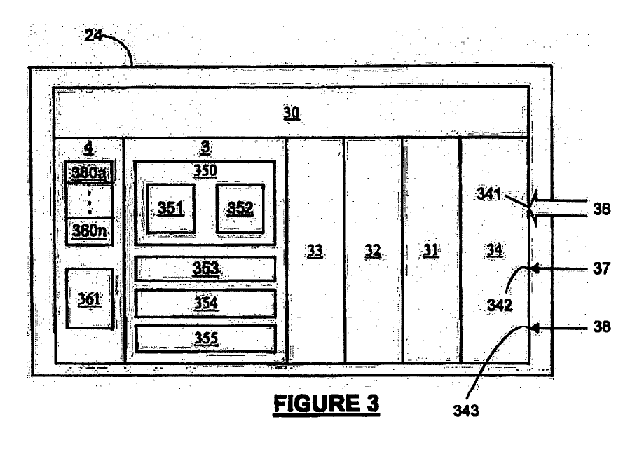

The trusted device 24 comprises a number of blocks, as illustrated in FIG. 3. After system reset, the trusted device 24 performs a secure boot process to ensure that the operating system of the platform 10 (including the system clock and the display on the monitor) is running properly and in a secure manner. During the secure boot process, the trusted device 24 acquires an integrity metric of the computing platform 10. The trusted device 24 can also perform secure data transfer and, for example, authentication between it and a smart card via encryption/decryption and signature/verification. The trusted device 24 can also securely enforce various security control policies, such as locking of the user interface.

Specifically, the trusted device comprises: a controller 30 programmed to control the overall operation of the trusted device 24, and interact with the other functions on the trusted device 24 and with the other devices on the motherboard 20; a measurement function 31 for acquiring the integrity metric from the platform 10; a cryptographic function 32 for signing, encrypting or decrypting specified data; an authentication function 33 for authenticating a smart card; and interface circuitry 34 having appropriate ports (36, 37 & 38) for connecting the trusted device 24 respectively to the data bus 26, control lines 27 and address lines 28 of the motherboard 20. Each of the blocks in the trusted device 24 has access (typically via the controller 30) to appropriate volatile memory areas 4 and/or non-volatile memory areas 3 of the trusted device 24. Additionally, the trusted device 24 is designed, in a known manner, to be tamper resistant.

For reasons of performance, the trusted device 24 may be implemented as an application specific integrated circuit (ASIC). However, for flexibility, the trusted device 24 is preferably an appropriately programmed micro-controller. Both ASICs and micro-controllers are well known in the art of microelectronics and will not be considered herein in any further detail.

One item of data stored in the non-volatile memory 3 of the trusted device 24 is a certificate 350. The certificate 350 contains at least a public key 351 of the trusted device 24 and an authenticated value 352 of the platform integrity metric measured by a trusted party (TP). The certificate 350 is signed by the TP using the TP's private key prior to it being stored in the trusted device 24. In later communications sessions, a user of the platform 10 can verify the integrity of the platform 10 by comparing the acquired integrity metric with the authentic integrity metric 352. If there is a match, the user can be confident that the platform 10 has not been subverted. Knowledge of the TP's generally-available public key enables simple verification of the certificate 350. The non-volatile memory 35 also contains an identity (ID) label 353. The ID label 353 is a conventional ID label, for example a serial number, that is unique within some context. The ID label 353 is generally used for indexing and labelling of data relevant to the trusted device 24, but is insufficient in itself to prove the identity of the platform 10 under trusted conditions.

The trusted device 24 is equipped with at least one method of reliably measuring or acquiring the integrity metric of the computing platform 10 with which it is associated. This gives a potential user of the platform 10 a high level of confidence that the platform 10 has not been subverted at a hardware, or BIOS program, level. Other known processes, for example virus checkers, will typically be in place to check that the operating system and application program code has not been subverted.

The measurement function 31 has access to: non-volatile memory 3 for storing a hash program 354 and a private key 355 of the trusted device 24, and volatile memory 4 for storing acquired integrity metric in the form of a digest 361. In appropriate embodiments, the volatile memory 4 may also be used to store the public keys and associated ID labels 360a-360n of one or more authentic smart cards 19 that can be used to gain access to the platform 10.

Acquisition of an integrity metric is not material to the present invention, and is not discussed further here—this process, and the process of verifying the integrity of a trusted platform by a user or a third party, are processes discussed in detail in International Patent Application Publication No. WO00/48063.

As indicated above, a preferred means for authenticating a user to a trusted platform is a token device, such as a smart card 19 (though it should be noted that a user could, for example, be a remote platform communicating with the trusted platform over a network). The user's smart card 19 is a token device, separate from the computing entity, which interacts with the computing entity via the smart card reader port 19. A user may have several different smart cards issued by several different vendors or service providers, and may gain access to the internet or a plurality of network computers from any one of a plurality of computing entities as described herein, which are provided with a trusted component and smart card reader. A user's trust in the individual computing entity to which s/he is using is derived from the interaction between the user's trusted smart card token and the trusted component of the computing entity. The user relies on their trusted smart card token to verify the trustworthiness of the trusted component.

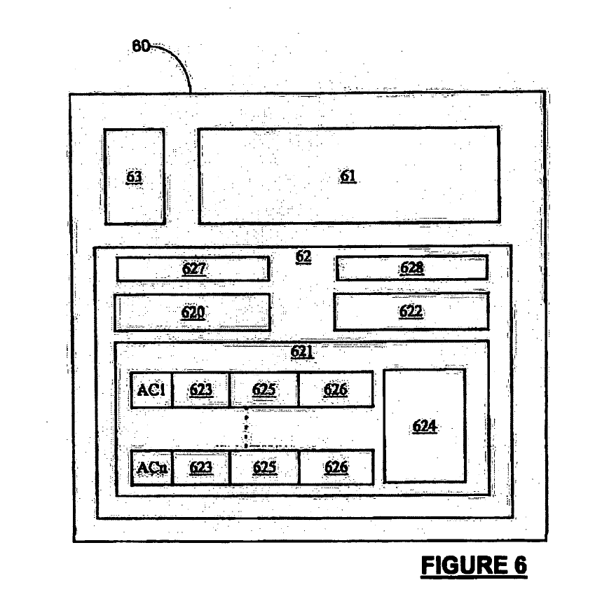

A processing part 60 of a user smart card 19 is illustrated in FIG. 6. As shown, the user smart card 19 processing part 60 has the standard features of a processor 61, memory 62 and interface contacts 63. The processor 61 is programmed for simple challenge/response operations involving authentication of the user smart card 19 and verification of the platform 10, as will be described below. The memory 62 contains its private key 620, its public key 628, (optionally) a user profile 621, the public key 622 of the TP and an identity 627. The user profile 621 lists the individual security policy 624 for the user (and may, for example, contain information relating to auxiliary cards usable by that user). The ‘security policy’ 624 dictates the permissions that the user has on the platform 10—for example, certain files or executable programs on the platform 10 may be made accessible or not in operation of the smart card 19 or an associated auxiliary smart card.

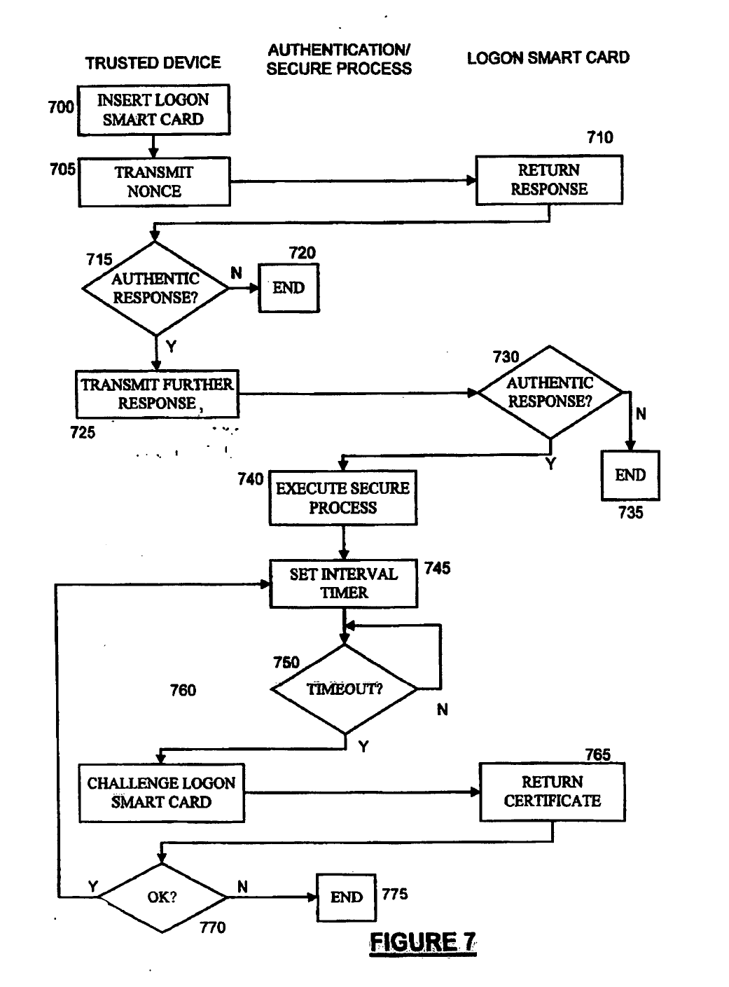

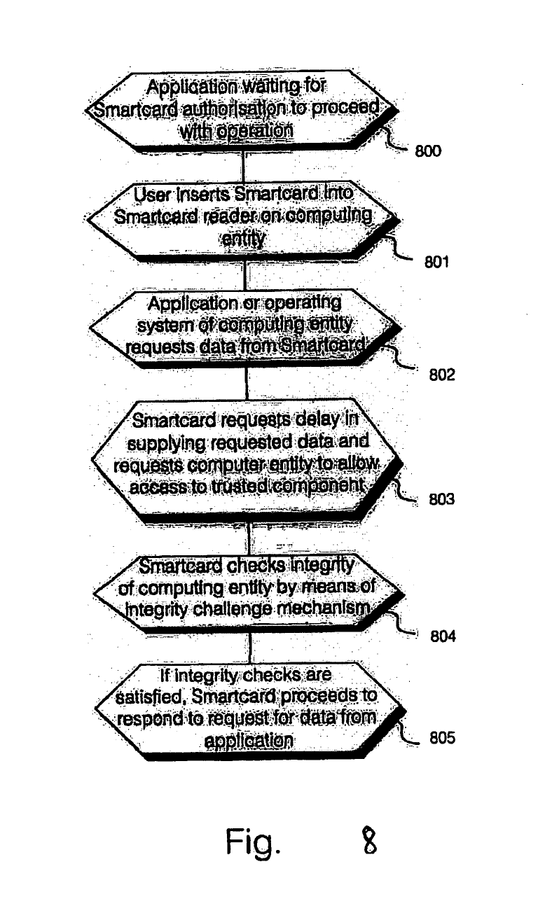

A preferred process for authentication between a user smart card 19 and a platform 10 will now be described with reference to the flow diagram in FIG. 7. As will be described, the process conveniently implements a challenge/response routine. There exist many available challenge/response mechanisms. The implementation of an authentication protocol used in the present embodiment is mutual (or 3-step) authentication, as described in ISO/IEC 9798-3. Of course, there is no reason why other authentication procedures cannot be used, for example 2-step or 4-step, as also described in ISO/IEC 9798-3.

Initially, the user inserts their user smart card 19 into the smart card reader 12 of the platform 10 in step 700. Beforehand, the platform 10 will typically be operating under the control of its standard operating system and executing the authentication process, which waits for a user to insert their user smart card 19. Apart from the smart card reader 12 being active in this way, the platform 10 is typically rendered inaccessible to users by ‘locking’ the user interface (i.e. the screen, keyboard and mouse).

When the user smart card 19 is inserted into the smart card reader 12, the trusted device 24 is triggered to attempt mutual authentication in step by generating and transmitting a nonce A to the user smart card 19 in step 705. A nonce, such as a random number, is used to protect the originator from deception caused by replay of old but genuine responses (called a ‘replay attack’) by untrustworthy third parties.

In response, in step 710, the user smart card 19 generates and returns a response comprising the concatenation of: the plain text of the nonce A, a new nonce B generated by the user smart card 19, the ID 353 of the trusted device 24 and some redundancy; the signature of the plain text, generated by signing the plain text with the private key of the user smart card 19; and a certificate containing the ID and the public key of the user smart card 19.

The trusted device 24 authenticates the response by using the public key in the certificate to verify the signature of the plain text in step 715. If the response is not authentic, the process ends in step 720. If the response is authentic, in step 725 the trusted device 24 generates and sends a further response including the concatenation of: the plain text of the nonce A, the nonce B, the ID 627 of the user smart card 19 and the acquired integrity metric; the signature of the plain text, generated by signing the plain text using the private key of the trusted device 24; and the certificate comprising the public key of the trusted device 24 and the authentic integrity metric, both signed by the private key of the TP.

The user smart card 19 authenticates this response by using the public key of the TP and comparing the acquired integrity metric with the authentic integrity metric, where a match indicates successful verification, in step 730. If the further response is not authentic, the process ends in step 735.

If the procedure is successful, both the trusted device 24 has authenticated the user smart card 19 and the user smart card 19 has verified the integrity of the trusted platform 10 and, in step 740, the authentication process executes the secure process for the user. Then, the authentication process sets an interval timer in step 745. Thereafter, using appropriate operating system interrupt routines, the authentication process services the interval timer periodically to detect when the timer meets or exceeds a pre-determined timeout period in step 750.

Clearly, the authentication process and the interval timer run in parallel with the secure process.

When the timeout period is met or exceeded, the authentication process triggers the trusted device 24 to re-authenticate the user smart card 19, by transmitting a challenge for the user smart card 19 to identify itself in step 760. The user smart card 19 returns a certificate including its ID 627 and its public key 628 in step 765. In step 770, if there is no response (for example, as a result of the user smart card 19 having been removed) or the certificate is no longer valid for some reason (for example, the user smart card has been replaced with a different smart card), the session is terminated by the trusted device 24 in step 775. Otherwise, in step 770, the process from step 745 repeats by resetting the interval timer.

In a preferred arrangement, the monitor 18 may be driven directly by a monitor subsystem contained within the trusted component itself. In this embodiment, in the trusted component space are resident the trusted component itself, and displays generated by the trusted component on monitor 18. This arrangement is described further in the applicant's International Patent Application Publication No. WO00/73879, which is incorporated by reference herein.

As can be seen from the above, when a capability of the trusted component (such as provision of an integrity metric) is required by a user, this will normally be made available by authentication which uses a secret. The range of capabilities of a trusted component is discussed more fully in Chapter 4 of “Trusted Computing Platforms: TCPA Technology in Context”—these can include giving a user a particular status with respect to a trusted component (such as ownership), and the enablement or disablement of operation of the trusted component (typically until the next system boot). However, as noted in “Trusted Computing Platforms: TCPA Technology in Context”, authentication by means of a secret may not always be available: in set-up of a new trusted platform for a user (or perhaps an existing trusted platform for a new user); in error conditions; or when a secret has been lost.

The most secure form of physical presence—in the sense of minimising risk of subversion by another process—is by a physical switch at the trusted platform hardwired to the trusted component itself (essentially the type of solution provided by switch 46 in FIG. 4). It is desirable for such a switch to be provided for at least the most significant of the commands that can be made to the trusted component—those which affect the privacy of the owner and the security of the trusted platform. However, while this is desirable, it has the significant disadvantage of significantly (in relation to the margins involved in the relevant business) increasing the cost of producing a computer platform. A cheaper solution is to provide physical presence commands by means of keystrokes at a stage in the boot process when subversion by rogue software would be difficult to achieve, such as during the earlier parts of BIOS boot. This alternative process is suggested in “Trusted Computing Platforms: TCPA Technology in Context” (see pp 100-101, for example). Even so, both these solutions have the undesirable characteristic that they merely detect the presence of a person, not the presence of the owner (the person or other entity genuinely entitled to control the trusted device and hence the trusted platform).

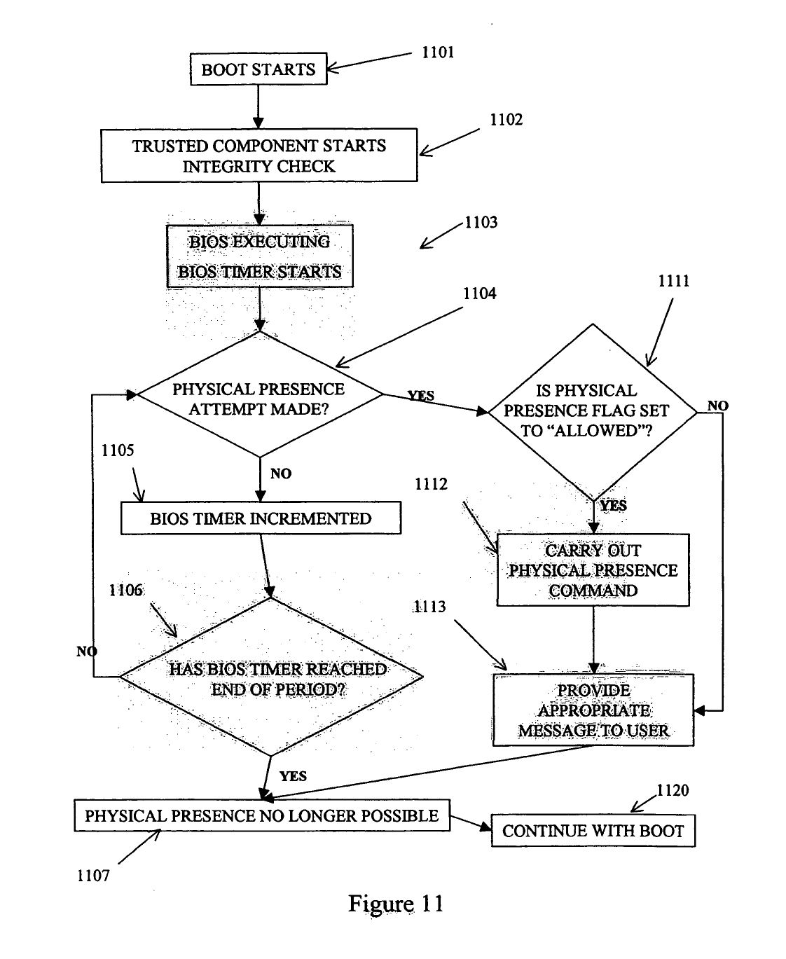

Modification to the trusted platform described above to achieve embodiments of the invention is described below. As for the first embodiment, the steps illustrated in FIG. 9 summarise the steps to be taken. For a trusted platform as described above and employing a physical presence mechanism utilising keyboard presses made during the boot process of the trusted platform, it is desirable to show the further steps to be taken in the authentication of a user's smart card (shown in FIG. 10, which is derived from FIG. 7) and to see how the disablement of physical presence fits in with the boot process more generally (shown in FIG. 11).

The commands to be provided by the user relate to altering aspects of the operation of the trusted device—most fundamentally, whether the trusted device is to operate as a trusted device or not, but other aspects of its operation (for example, logging of executing applications) could be switched this way. Note that there is no reason why the command set for provision by an authenticated user should directly match the command set for provision by a physically present user—as we shall see below, suppression of the physical presence mechanism is not logically linked to demonstration that an appropriately authenticated user has altered an aspect of the operation of the trusted device within a certain time, but only that they had the capacity to do so.

The logical starting state for the system is for physical presence to be allowed—this allows the first owner of the trusted platform to establish themselves as the owner by means of the physical presence mechanism. For the trusted device itself (considering FIG. 3), whether physical presence is allowed or not allowed will depend on the state of a physical presence flag in the non-volatile memory 3 of the trusted device—so it can be taken that the initial state of this physical presence flag will be “allowed”.

Considering FIG. 9, the first step of interest is the authentication of the user to the trusted component by establishing possession of a secret in step 91—this is the process set out with reference to FIG. 10, which shows a modification to the authentication process of FIG. 7 (reference numerals in FIG. 10 have the same meaning as in FIG. 7). The second step 92 shown in FIG. 9 involves the disablement of physical presence—here by the trusted component changing the state of the physical presence flag to “not allowed”, and the starting of a timer. This timer may be driven by a clock within the trusted device (not shown in FIG. 3) or by a clock outside the trusted device—either in the trusted platform itself, or even remotely from the trusted platform (for example, by a trusted time source or timestamping source). The timer mechanism will continue counting until a predetermined time (as discussed above, the length of this time can be chosen dependent on the specific circumstances, but will typically be of the order of days) has been reached, at which point the physical presence flag will be reset to “allowed”. The timer mechanism is here started at step 725A, when the user's smart card has been successfully authenticated to the trusted device. Preferably, the timer mechanism could be restarted at any reauthentication (such as at step 770A) during a session—though given that the timer period is likely to be significantly longer than the normal length of a session, this approach may not be necessary.

Although the discussion here relates to the authenticated user as being the possessor of a smart card and physically proximate to the trusted platform, this is not necessarily the case. More generally, a person may use a separate computing device instead of a smart card, and may be in a different physical location to the trusted device. The user may be a process instead of a person. User secrets may be used for several purposes, including authorisation to use keys inside the trusted device. There may not be a single secret to which the timer is linked—for example, the timer may be restarted upon proof to the trusted device of possession by an external entity of more than one secret used for authentication to the trusted device or authorisation for actions by the trusted device.

It is also possible for there to be separate timers for different commands (or for different aspects of operation of the trusted device). Indeed, there is no reason why the command set for provision by an authenticated user should directly match the command set for provision by a physically present user.

The boot process of the trusted platform will now be considered—this is shown in FIG. 11.

The boot process for the trusted platform starts (step 1101) with the platform seeking the first instruction—as is discussed above, it is preferred for a trusted platform that the trusted platform looks to the trusted component to provide at least the first stages of the boot process. The trusted component will then begin the process of integrity measuring (step 1102)—as stated in “Trusted Computing Platforms: TCPA Technology in Context”, it is preferred that this takes the form of measuring the processes as they are carried out, which provides the possibility for stopping or commenting the boot process if unexpected results occur. Integrity measuring will or can therefore continue throughout the following steps of the boot process.

The BIOS is now executing to boot up the computer, beginning with the Power-on Self-Test diagnostic check of the system hardware (step 1103) and continuing through to loading of the operating system. In this embodiment of the invention, the BIOS also provides a window during which physical presence commands can be made to the trusted component.—a timing loop is started at this point. In fact, the most convenient implementation is to integrate physical presence detection with the boot choices offered by most BIOSes.

In the timing loop of FIG. 11, the main processor of the trusted platform checks to see whether an attempt to control the trusted component by physical presence has been made (step 1104)—as indicated above, this is exactly the same timing loop as used by existing BIOSes to detect whether changes are to be made by the user before booting up the operating system. While a physical presence mechanism could be achieved by use of a dedicated switch, the solution adopted for practical purposes is for the physical presence attempt to be made by a predetermined keystroke or set of keystrokes from the keyboard (most conveniently, by the same keystroke that is used to make user changes before the operating system boots). If no such keyboard event is detected, the timing loop moves on to incrementation of the BIOS timer (step 1105) and a check to see whether the BIOS timer has reached the end of the physical presence period (step 1106). If the period has not yet ended (the duration of the period can obviously be chosen to be whatever is considered appropriate—probably a few seconds at most), the loop continues and another check for physical presence is made (step 1104). Optionally (not shown) another keystroke can be used to terminate the period prematurely (as is done by use of the RETURN key to boot the operating system without making changes in standard BIOS). If the period has ended, physical presence is rendered no longer possible (step 1107)—perhaps most advantageously by setting of a further flag in the trusted component to indicate that the trusted platform can now (for this purpose) be considered booted, the flag being reset on poweroff. The boot then continues to its conclusion (step 1120).

If a physical presence attempt is detected, this is offered to the trusted component, which determines whether the physical presence flag is set to “allowed” (step 1111, also step 94 of FIG. 9). As indicated previously, this will only be the case if the physical presence timer for the trusted component has timed out. If the flag is set to “allowed” the physical presence command will be carried out (step 1112), but if the flag is set to “not allowed”, the command will not be carried out. In either case, it is appropriate to provide a message to the user to indicate whether or not the attempted physical presence command has been carried out. If the BIOS timer here is the same one that can be used to give manual control of the boot process, the possibility of making physical presence commands to the trusted component may simply be one of the choices listed in the list of boot choices offered to the user by a standard BIOS, and can be offered to the user in exactly the same way (the physical presence command can be entered directly, or selected from a menu, in conventional manner). If physical presence is not available for one or more commands, this can be displayed by the BIOS directly (so as not to confuse or annoy the user). When the user has made physical presence commands, and any other changes to the boot process, the user will be asked to confirm, and the physical presence commands will be made to the trusted component. The boot can continue at this point (step 1120)—clearly there is no point in returning to the timing loop. Again, the possibility of physical presence without a further boot should be prevented, advantageously as described above by the setting of the further flag in the trusted component.

The BIOS timer is different to the physical presence timer whose actions are illustrated in FIG. 9. The BIOS timer of FIG. 11 is used here to determine whether a window for asserting physical presence is open (it may, as indicated above, have other uses). The physical presence timer of FIG. 9 is used by the trusted device to determine whether assertions of physical presence during such a window will be acted upon.

This is not the only possible solution. It would be perfectly possible (though not ideal, because of the risk of subversion) to set a window for making physical presence commands outside the boot process altogether. It would also be possible to use physical presence mechanisms which while still dependent on key presses, would be harder to subvert by malicious code or by a remote device than known key press choices—an example would be the display to the user of a complex pattern that would not be intelligible to a non-human user because code will not recognise the pattern as text (such a mechanism is provided in U.S. Pat. No. 6,195,698). Generically, such mechanisms are described as “Inverse Turing tests”. This could be implemented, for example, by providing a message such as “To enable trusted operation, enter the eight characters XXXXXXXX”, where these characters would preferably be chosen at random by the trusted device and rendered by the inverse Turing test code. This randomness prevents a software agent mounting a replay attack during the next boot sequence by sending previously captured keyboard events to the trusted device. The “complex pattern” would prevent a software agent from recognising the current set of eight characters. This approach could be carried out straightforwardly where physical presence commands to the trusted component are addressed together with other user choices made before the BIOS boots up the operating system.

This example will now be considered more specifically in terms of TCPA commands and the TCPA specification. The term “watchdog timer”, introduced in the discussion of FIG. 9, will be used below to describe physical presence timers such as that shown in FIG. 9. The term “TPM” (Trusted Platform Module) is used for the trusted device, as this is the generally used acronym within TCPA. An owner-authorisation value is a secret used to establish that a user is an owner—as discussed above, embodiments of the presence invention can operate with one such secret, or with multiple secrets, or even different secrets for different commands or functions (however, as no different principles are employed in using multiple secrets, these will not be discussed in specific examples—the skilled person requires no specific direction on this point).

Suppose a TPM has multiple watchdog timers, one for each physical presence control, and a single owner-authorisation value. The existing command TPM_PhysicalEnable, which requires proof of physical presence before it will operate, will be considered. The TCPA command ordinal of TPM_PhysicalEnable is 111.

To implement the second embodiment of the invention in this context, the new command TPM_SetPPWatchdog( ) can be introduced. This command has the properties that it is cryptographically authorised using owner-authorisation and passes to the TPM the parameters (1) on-flag; (2) control-ordinal; (3) timeout; (4) background-flag. It implicitly passes proof of owner-authorisation.

“on-flag” indicates whether the watchdog for the control having TCPA ordinal “control-ordinal” is active or inactive.

“timeout” is the value to which the watchdog is set when it is set.

“background-flag” indicates whether the watchdog for the control “control-ordinal” is set to the value “timeout” on receipt of any command that passes proof of the particular authorisation value “owner-authorisation”.

Thus, on receipt of the correctly authorised command TPM_SetPPWatchdog(on-flag=TRUE; control-ordinal=111; timeout=50; background-flag=TRUE), the TPM:

Sets the watchdog preset-value for the command TPM-PhysicalEnable to 50 hours

Sets an internal flag such that the TPM will set the watchdog for the command TPM-PhysicalEnable to 50 hours whenever owner-authorisation is used.

Activates the watchdog for the command TPM-PhysicalEnable by setting it to the watchdog preset-value for the command TPM_PhysicalEnable.

Normally, the TPM owner issues the command TPM_SetPPWatchdog(on-flag=TRUE; control-ordinal=111; timeout=50; background-flag=TRUE) once every day. Then, as preferred, the watchdog for TPM_PhysicalEnable never times out in normal operation, and TPM-PhysicalEnable is disabled. Whenever owner-authorisation is used, for whatever purpose, the TPM-PhysicalEnable watchdog is automatically set to 50 hours. Hence it may not always be necessary for the owner to issue TPM_SetPPWatchdogo every day. If the owner forgets the value of owner-authorisation, eventually the TPM_PhysicalEnable watchdog will timeout, and TPM-PhysicalEnable becomes operational.

If it is desired to make physical presence commands possible immediately (ie suppress the disablement mechanism), this can simply be done by adding another command to the command set. This further TPM command, which would also need to be cryptographically authorised using owner-authorisation, could cause the watchdog timer or timers to time-out, thus immediately enabling physical presence commands.

Embodiments of the present invention can thus be used to ensure that computer systems, and particularly trusted platforms, can be rendered more secure by limiting the possibility of issuing commands by a physically present but unauthenticated user to situations in which there has not been a secret-based user authentication for some period of time.

1. A computer system comprising a processor arranged to alter at least one aspect of operation only if a command to alter that at least one aspect is provided by a valid user,
whereby for the at least one aspect of operation, a valid user may be a user authenticated by the processor by establishing that the user possesses a secret or a user who satisfies a condition for physical presence at the computer system; and
whereby for a predetermined time after authentication by establishment of possession of the secret has taken place, the processor is adapted not to be responsive to the command to alter that at least one aspect when issued by a user who is not authenticated by the processor but who satisfies a condition for physical presence at the computer system.

2. A computer system as claimed in claim 1, wherein the processor is adapted to carry out authentication of a user as an entity identified by cryptographic communication.

3. A computer system as claimed in claim 2, wherein the entity is in communication with the computer system over a data network connection of the computer system.

4. A computer system as claimed in claim 1, wherein the computer system is in communication with a smart card reader, and whereby the processor is adapted to authenticate a user by means of a smart card inserted into the smart card reader.

5. A computer system as claimed in claim 1, wherein the computer system further comprises a memory having a flag which when set indicates that the processor will be responsive to the at least one command when provided by a user who satisfies the condition for physical presence, the flag being set by authentication of the user and unset by the lapse of a predetermined period of time since authentication of the user.

6. A computing platform comprising a main processor and a computer system as claimed in claim 1 as a coprocessor.

7. A computing platform as claimed in claim 6 wherein the condition for physical presence can be satisfied only during a boot process for the main processor.

8. A computing platform as claimed in claim 7 wherein a physical presence mechanism comprises one or more predetermined key presses during a part of the boot process.

9. A method of control of a processor responsive to a command or commands to alter at least one aspect of operation only if provided under specified conditions, comprising the steps of:
the processor authenticating the user by establishing that they possess a secret and starting a timer;
if a predetermined period has not elapsed on the timer, the processor refusing to respond to the at least one command issued by a user who demonstrates physical presence at a computer system comprising the processor but does not provide authentication by possession of the secret; and
if the predetermined period has elapsed on the timer, the processor responding to the at least one command issued by a user who demonstrates physical presence at the computer system comprising the processor.

10. A method as claimed in claim 9, wherein the step of authenticating the user takes place by cryptographic communication.

11. A method as claimed in claim 9, wherein the step of authenticating the user comprises communicating with a user smart card.

12. A method as claimed in claim 9, wherein the processor is a coprocessor of the computer system having a main processor, and wherein demonstration of physical presence comprises a determination by the main processor that key press events have occurred.

13. A method as claimed in claim 12, wherein the key press events are determined as providing a demonstration of physical presence only during a part of a boot process for the main processor.

14. A trusted computing platform containing a main processor and a trusted component, the trusted component being physically and logically resistant to subversion and containing a trusted component processor, wherein the trusted component processor is adapted to report on the integrity of at least some operations carried out on the main processor and has at least one command to which it is responsive only if it is provided by a valid user of the trusted computing platform;
whereby for the at least one command, a valid user may be a user authenticated by the trusted component processor by establishing that the user possesses a secret or a user who satisfies a condition for physical presence at the trusted computing platform; and
whereby for a predetermined time after authentication by establishment of possession of the secret has taken place, the trusted component processor is adapted not to be responsive to the at least one command when issued by a user who is not authenticated by the processor but who satisfies a condition for physical presence at the computer system.

15. A trusted computing platform as claimed in claim 14, further comprising a smart card reader whereby the trusted component processor is adapted to authenticate a user by means of a user smart card placed in the smart card reader.

16. A trusted computing platform as claimed in claim 14, wherein the condition for physical presence can be satisfied only during a boot process for the main processor.

17. A trusted computing platform as claimed in claim 16, wherein a physical presence mechanism comprises one or more predetermined key presses during a part of the boot process.

18. A data carrier having stored thereon executable code whereby a processor programmed by the executable code:
recognises a command or commands to alter at least one aspect of operation which can be made to the processor as being executable only if provided by a valid user;
identifies a valid user for the at least one command as being a user authenticated by the processor as the possessor of a secret;
on determination that a user has been authenticated by the processor as the possessor of a secret, starts timing for a predetermined period;
if the predetermined period has not elapsed, refuses to respond to the at least one command issued by a user who is not authenticated as possessor of a secret but who is recognised by the processor as demonstrating physical presence at a computer system of which the processor is a part; and
if the predetermined period has elapsed, responding to the at least one command issued by a user who is recognised by the processor as demonstrating physical presence at the computer system of which the processor is a part.

19. A method of control of a processor responsive to a command or commands to alter at least one aspect of operation only if said command or commands is or are provided by a valid user, comprising the steps of:
determining a first method for the processor to identify a valid user having a higher level of assurance, and a second method for the processor to identify a valid user having a lower level of assurance;
the processor identifying the user with the first method and starting a timer;
if a predetermined period has not elapsed on the timer, the processor refusing to respond to the command or commands issued by a user identified by the second method but not by the first method; and
if the predetermined period has elapsed on the timer, the processor responding to the command or commands issued by a user identified by the second method.

20. A computer system comprising a processor arranged to alter at least one aspect of operation only if a command to alter that at least one aspect is provided by a valid user,
whereby for the at least one aspect of operation, a valid user may be a user identified by the processor by a method that provides a higher degree of assurance that the user is a valid user or by a method that provides a lower degree of assurance that the user is a valid user; and
whereby for a predetermined time after identification by the method that provides a higher degree of assurance, the processor is adapted not to alter the at least one aspect of operation by a user identified by the method that provides a lower degree of assurance.
